(19) United States
(12) Patent Application Publication
(10) Pub. No.: US 2006/0266683 A1
(43) Pub. Date: Nov. 30, 2006

(54) Ozone water faucet

(76) Inventor: Wei-Ming Sung, Banciao City (TW)

Correspondence Address: TROXELL LAW OFFICE PLLC;SUITE 1404, 5205 LEESBURG PIKE, FALLS CHURCH, VA, 22041, US

(21) Appl. No.: 11/442,347

(22) Filed: May 30, 2006

(30) Foreign Application Priority Data
May 30, 2005 (TW) 094208880

(51) Int. Cl. C02F 1/78

(52) U.S. Cl. 210/198.1; 210/760

(57) ABSTRACT

An ozone water faucet having an ozone supplier disposed on an outcome of a faucet is disclosed. The ozone supplier consists of a gas-liquid mixing tube and an ozone generator. The gas-liquid mixing tube is composed by a water intake section, a water drainage section, and a diameter-reducing throat therebetween. The ozone from the ozone generator flows through the diameter-reducing throat, into the gas-liquid mixing tube. A cut out bearing is arranged inside the water drainage section for mounting a cut out stirring ball that moves freely. When water flows through the diameter-reducing throat, into the water drainage section, it flushes the cut out stirring ball as well as the bearing and drives the cut out stirring ball moving upwards and downwards so as to have better disintegration effect on the water.

### BACKGROUND OF THE INVENTION

The present invention relates to an ozone water faucet, especially to a faucet disposed with ozone supplier on top thereof so as to make ozone solve inside water from the faucet for disinfection.

Generally, quality of water flowing from the faucet is not stable and unreliable. The ozone has functions of disinfection and sterilization. Moreover, the solubility of ozone in the water is as high as 25%. Thus once the ozone gas is mixed with water, the water is purified, disinfected and sterilized effectively. Although there is already an ozone water faucet available on market such as Taiwanese publication No. 48660 and No. M261283, it is still a key point that how to effectively increase solubility of ozone in water.

### SUMMARY OF THE INVENTION

Therefore it is a primary object of the present invention to provide an ozone water faucet having an ozone supplier disposed on an outcome of a faucet. The ozone supplier includes a gas-liquid mixing tube and an ozone generator. The gas-liquid mixing tube consists of a water intake section, a water drainage section, and a diameter-reducing throat between the water intake section and the water drainage section. A cut out bearing is arranged inside the water drainage section and is having an arced slot on top thereof for mounting a cut out stirring ball that moves freely. In usage, while water flowing through the diameter-reducing throat, into the water drainage section, the cut out stirring ball is driven to move upwards and downwards so as to have better disintegration effect on water. Thus the ozone gas and water are mixed more efficiently.

It is another object of the present invention to provide an ozone water faucet that includes a turbulent guiding plate with a plurality of turbulent blades is arranged on a top end of the intake section of the gas-liquid mixing tube so as to increase speed of the water flowing into the water intake section of the gas-liquid mixing tube as well as the diameter-reducing throat is increased.

It is a further object of the present invention to provide an ozone water faucet in which an ozone generator is turned on by a water sensing switch with two electrical contacts (positive and negative electrodes). The two electrical contacts are disposed projectingly inside an inner surface of the gas-liquid mixing tube at different heights so as to form height difference between the two electrical contacts. Thus the operation of switches is more precise and the off of the ozone generator 40 won't be interfered by the residual water.

### BRIEF DESCRIPTION OF THE DRAWINGS

FIG. 1 is a perspective view of an embodiment in accordance with the present invention;

FIG. 2 is an explosive view of the embodiment in FIG. 1 in accordance with the present invention;

FIG. 3 is a cross sectional view of the embodiment in FIG. 1 in accordance with the present invention;

FIG. 4 is a schematic drawing showing cross section of part of the embodiment in FIG. 1 in accordance with the present invention;

FIG. 5 is a schematic drawing showing a cut out bearing and a stirring ball in accordance with the present invention.

### DETAILED DESCRIPTION OF THE PREFFERED EMBODIMENT

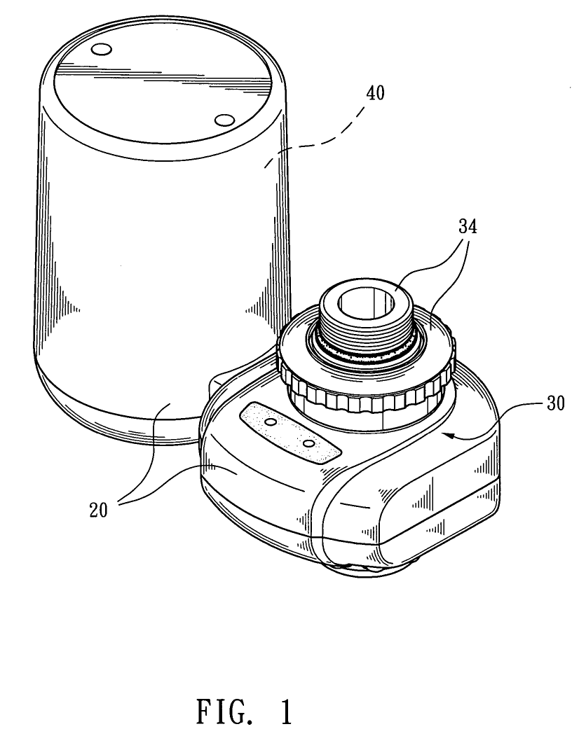

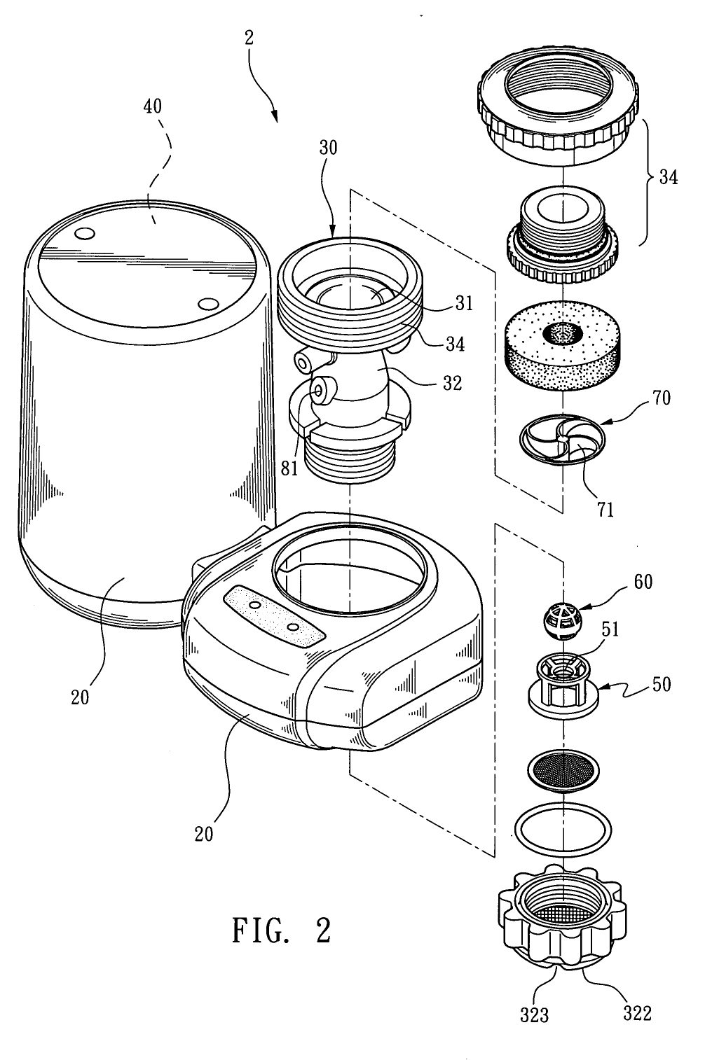

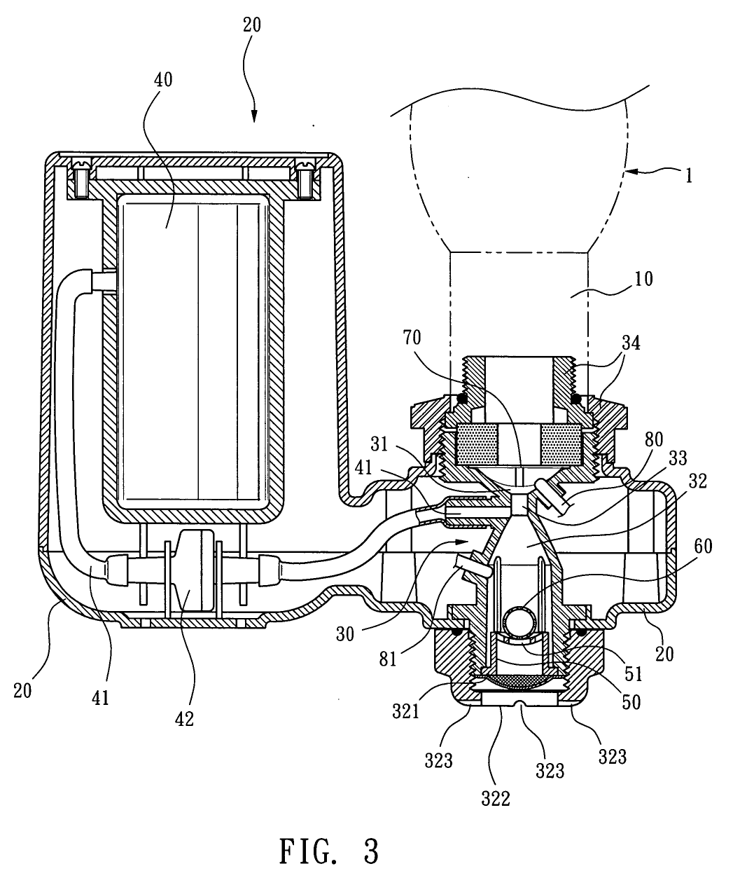

Refer from FIG. 1 to FIG. 3, an ozone water faucet 1 according to the present invention includes an ozone supplier 2 disposed on an outcome 10 of a faucet. The ozone supplier 2 consists of a housing 20, a gas-liquid mixing tube 30 and an ozone generator 40. Both the gas-liquid mixing tube 30 and the ozone generator 40 are mounted inside the housing and connected with external power sources. The gas-liquid mixing tube 30 is a hourglass tube with larger diameter on two ends and smaller diameter in center part, composed by a water intake section 31, a water drainage section 32, and a diameter-reducing throat 33. The water intake section 31 is sleeved on top of the outcome 10 of the faucet 1 so that water from the outcome 10 directly flows into the intake section 31 of the gas-liquid mixing tube 30. A connecting part 34 is disposed between the intake section 31 and the outcome 10 of the faucet 1 for connection the two parts and there is no limit on connecting way of the connecting part 34, depending on structure of the outcome 10 of the faucet 1 such as inner teeth type faucet, outer teeth type or traditional faucets.

The ozone generator 40 is used to produce ozone gas while the detailed structure of the ozone generator 40 is not described hereunder because such kind of technology is a prior art. The ozone gas produced from the ozone generator 40 is released into the gas-liquid mixing tube 30 through a pipe 41 connected with the diameter-reducing throat 33 of the gas-liquid mixing tube 30. The pipe 41 can be disposed with a check valve 42 for preventing a backflow of water from the gas-liquid mixing tube 30 to the ozone generator 40.

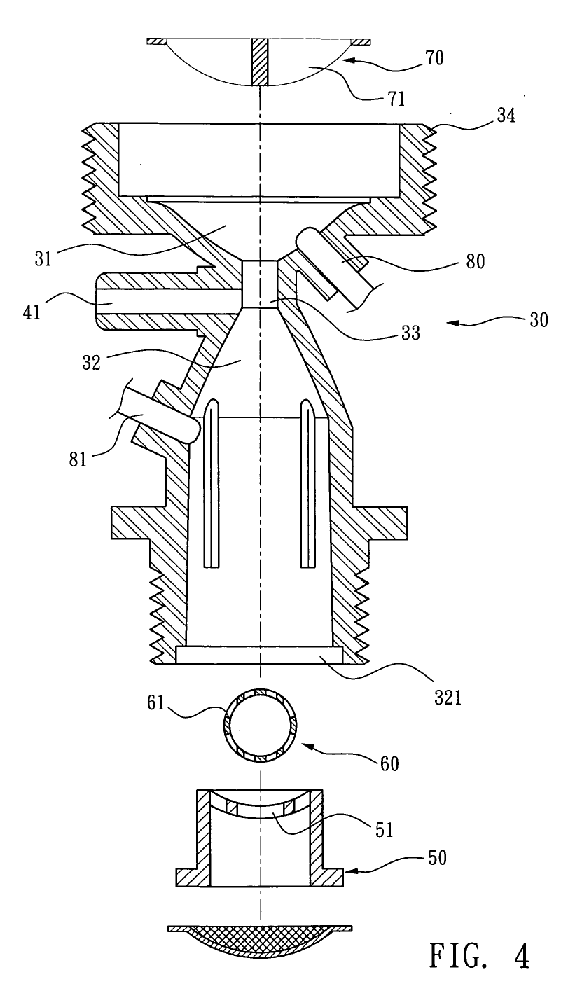

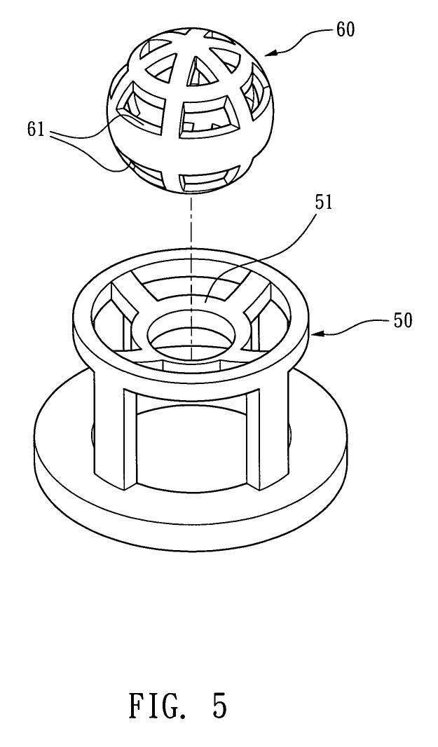

Refer to FIG. 4 & FIG. 5, a cut out bearing 50 and a cut out stirring ball 60 are mounted inside the water drainage section 32 of the gas-liquid mixing tube 30. The cut out bearing 50 is a cut out rack fixed on an outer end 321 of the water drainage section 32 to make the water flow from the diameter-reducing throat 33, through the water drainage section 32, pass cut out area of the cut out bearing 50, then being discharged externally. Top of the cut out bearing 50 is an arced slot 51 whose arc depends on diameter of the stirring ball 60 so that part of sphere of the stirring ball 60 matches with the arced slot 51 to form a contact plane on a routeway of the water drainage section 32. This also increases free space of the stirring ball 60 between the arced slot 51 and the diameter-reducing throat 33. Moreover, the cut out stirring ball 60 moves freely with cut out sphere. When the cut out stirring ball 60 is in the routeway of the water drainage section 32, no matter it stays on the arced slot 51 or moves upwards and downwards due to water flush. The inner and outer surfaces of the cut out sphere contact with the water and generate relative motions so as to increase disintegration of the water.

Furthermore, a turbulent guiding plate 70 with a plurality of turbulent blades 71 is arranged on a top end 311 of the intake section 31 of the gas-liquid mixing tube 30 so that while passing through the turbulent guiding plate 70, speed of the water from the faucet 1 flowing into the water intake section 31 and the diameter-reducing throat 33 is increased. Thus the mixing force of the water with ozone in enhanced while passing through the diameter-reducing throat 33.

In usage, turn on the faucet 1, then water flows through the turbulent guiding plate 70, the water intake section 31 and the diameter-reducing throat 33 of the gas-liquid mixing tube 30m into the water drainage section 32. The water flow can directly flush on the arced slot 51 of the cut out bearing 50 or the cut out stirring ball 60. It also drives the cut out stirring ball 60 rolls freely between the arced slot 51 and the diameter-reducing throat 33. The edges of cut out area of the cut out stirring ball 60 and the bearing 50 are like disintegration ends 61. Especially the cut out stirring ball 60 not only has three-dimensional spherical cut out area but also rolls upwards and downwards freely so that its contact area as well as contact chances with water per unit time is increased. The cut out stirring ball 60 has better disintegration effect toward the water so that the solubility of ozone into water is increased. Therefore, the water with ozone has better disinfection, sterilization and purification effect.

In addition, the way to turn on the ozone generator 40 or the faucet 1 can be by a general switch, an infrared sensor, or a water sensing switch with two electrical contacts (positive and negative electrodes). Once the water sensing switch with two electrical contacts is used, the two electrical contacts 80, 81 are disposed projectingly inside the gas-liquid mixing tube 30 at different heights. For example, one of the two electrical contacts is on the water intake section 31 while the other is on the water drainage section 32 so as to form height difference between the two electrical contacts 80, 81. Thus it can be prevented that the two electrical contacts 80, 81 are connected with each other, in a turn-on status by residual water inside the gas-liquid mixing tube 30. The operation of switches is more precise and the off of the ozone generator 40 won't be interfered by the residual water.

A plurality of grooved surfaces 323 with certain height is arranged on circumference of an outcome surface 322 of the outer end 321 of the water drainage section 32 at a certain interval so as to form several lateral openings. Thus even the outcome surface 322 is covered by users' hand, water from the gas-liquid mixing tube 30 can still flow out through the grooved surfaces 323 (lateral openings) for preventing a backflow of water. Besides the check valve 42, there is one more safety device for protection of the ozone generator 40.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. An ozone water faucet comprising an ozone supplier disposed on an outcome of a faucet and the ozone supplier comprising a housing, a gas-liquid mixing tube, an ozone generator, a cut out bearing and a cut out stirring ball, wherein
the housing is for mounting the gas-liquid mixing tube and the ozone generator;
the gas-liquid mixing tube is a hourglass tube with larger diameter on two ends and smaller diameter in center part thereof, and having a water intake section, a water drainage section, and a diameter-reducing throat; the water intake section connects with the outcome of the faucet so that water from the outcome directly flows into the intake section;
the ozone generator is a device that generates ozone gas and the ozone gas is released into the gas-liquid mixing tube through a pipe connected between the ozone generator and the diameter-reducing throat;
the cut out bearing is a cut out rack fixed on an outer end of the water drainage section of the gas-liquid mixing tube to make water flow from the diameter-reducing throat, through the water drainage section, pass the cut out bearing and then being discharged externally; an arced slot whose arc matches diameter of the stirring ball is disposed on top of the cut out bearing so that part of sphere of the stirring ball mounts in the arced slot; the cut out stirring ball is a body moving freely with cut out sphere and is rolling upwards and downwards between the arced slot of the cut out bearing and the diameter-reducing throat of the gas-liquid mixing tube;
when water flows through the water intake section, the diameter-reducing throat into the water drainage section, it flushes the cut out stirring ball or the cut out bearing and drives the cut out stirring ball rolls vertically and freely between the arced slot on top of the cut out bearing and the diameter-reducing throat of the gas-liquid mixing tube so as to have disintegration effect on the water.

2. The device as claimed in claim 1, wherein the water intake section is connected with the outcome of the faucet by means of corresponding assembling parts.

3. The device as claimed in claim 1, wherein a check valve is disposed on the pipe of the ozone generator.

4. The device as claimed in claim 1, wherein a turbulent guiding plate disposed with a plurality of turbulent blades is arranged on a top end of the gas-liquid mixing tube so that water from the faucet passes through the turbulent guiding plate first and then flows into the water intake section.

5. The device as claimed in claim 1, wherein the ozone generator is turned on by a general switch, an infrared switch, or water sensing switch with positive and negative electrodes.

6. The device as claimed in claim 5, wherein two electrical contacts of the water sensing switch with positive and negative electrodes are disposed on an inner wall of the gas-liquid mixing tube so that the electrical contacts are electrically connected by water inside the gas-liquid mixing tube.

7. The device as claimed in claim 6, wherein the two electrical contacts are preferably disposed inside the gas-liquid mixing tube at different heights.

8. The device as claimed in claim 6, wherein one of the two electrical contacts is mounted inside the water intake section of the gas-liquid mixing tube while the other is inside the water drainage section of the gas-liquid mixing tube.

9. The device as claimed in claim 1, wherein a plurality of grooved surfaces with certain height is arranged on circumference of an outcome surface of the water drainage section of the gas-liquid mixing tube at a certain interval so as to form several lateral openings on the outcome surface.
